(19) United States
(12) Patent Application Publication
(10) Pub. No.: US 2018/0139343 A1
(43) Pub. Date: May 17, 2018

(54) NON-TRANSITORY RECORDING MEDIUM STORING COMPUTER READABLE PRINT SETTING HISTORY DISPLAY PROGRAM, PRINTING SYSTEM, AND SERVER

(71) Applicant: Konica Minolta, Inc., Tokyo (JP)

(72) Inventors: Shin IGAWA, Tokyo (JP); Yoshiyuki HARADA, Tokyo (JP)

(73) Assignee: Konica Minolta, Inc., Tokyo (JP)

(21) Appl. No.: 15/810,656

(22) Filed: Nov. 13, 2017

(30) Foreign Application Priority Data
Nov. 14, 2016 (JP) 2016-221256

(51) Int. Cl. H04N 1/00; G06F 3/0484; G06F 3/0482; H04N 1/32

(52) U.S. Cl. CPC H04N 1/00973; G06F 3/04847; G06F 3/0482; H04N 1/00344; H04N 2201/3222; H04N 1/00424; H04N 1/00933; H04N 2201/0094; H04N 1/32112

(57) ABSTRACT

An aspect of the present invention: stores, as print setting histories, contents of print setting as of the time of performing printing and information of documents subjected to printing processing in a print setting history holding unit; displays a list of the print setting histories stored in the print setting history holding unit on a print setting screen on which print setting is performed; and performs a print setting on the basis of a print setting history selected from the list of print setting histories displayed on the print setting screen. Then, in displaying the list of print setting histories on the print setting screen, only the latest print setting history is displayed from among the print setting histories classified into the same group satisfying predetermined conditions.

### CROSS-REFERENCE TO RELATED APPLICATIONS

This application claims priority to Japanese Patent Application 2016-221256 filed on Nov. 14, 2016, the entire disclosure of which is hereby incorporated by reference.

### BACKGROUND OF THE INVENTION

### Field of the Invention

The present invention relates to a non-transitory recording medium storing a computer readable print setting history display program which displays print setting histories on a print setting screen, a printing system, and a server.

### Description of the Related Art

Conventionally, there is a function referred to as “print setting history” as a print setting function of a printing apparatus provided from a printer driver. The “print setting history” function is a function of storing a print setting used at the time of printing processing (generated as a print job) as a history. A user can perform a desired print setting by selecting a desired print setting history from among a list of print setting histories displayed on a print setting screen which is a UI (User Interface) through the use of a function of the “print setting history”.

For example, Patent Literature 1 has disclosed therein a technique that makes a display unit display an operation history screen including: a list display region for displaying a list of operation history information (corresponding to print setting history) of image formation; and a detail display region for displaying details of operation history information selected from the list of operation history information on the basis of a selection instruction received by an operation unit. Accordingly, the user can easily find desired operation history information by referring to the list of operation history information (print setting history), and can also check the details of the selected operation history information.

### CITATION LIST

### Patent Literature

PTL 1: Japanese Patent Laid-Open No. 2009-284204

### SUMMARY OF THE INVENTION

### Problems to be Solved by the Invention

However, as described in the technique according to Patent Literature 1, display of all the print setting histories on the print setting screen at every time of printing results in increased list of print setting histories, thereby making it difficult to search for a desired print setting history from all the print setting histories, and lowering search characteristics. In addition, in a case where printing have been performed a plurality of times by using the same print setting in the mechanism of displaying all the print setting histories on the print setting screen, the same print setting remains in a plurality of print setting histories, thereby lowering the search characteristics. Furthermore, in such a mechanism, a similar but wrong print setting history remains in a case where printing have been performed in a wrong print setting, whereby the user may select an unexpected print setting history.

The present invention has been made in consideration of the abovementioned circumstances, and an object thereof is to enhance the search characteristics when a user selects a desired print setting history from among a list of print setting histories.

### Means for Solving the Problem

To achieve at least one of the abovementioned objects, according to an aspect, a non-transitory recording medium storing a computer readable print setting history display program of a first aspect of the present invention has stored therein a program including: storing, as print setting histories, contents of print setting at the time of performing printing and information of documents subjected to printing processing in a print setting history holding unit; displaying a list of the print setting histories stored in the print setting history holding unit on a print setting screen on which print setting is performed; and performing a print setting on the basis of a print setting history selected from the list of the print setting histories displayed on the print setting screen.

Here, in the step of displaying the list of the print setting histories on the print setting screen, only the latest print setting history is displayed from among print setting histories classified into the same group satisfying predetermined conditions.

To achieve at least one of the abovementioned objects, according to an aspect, a non-transitory recording medium storing a computer readable print setting history display program of a second aspect of the present invention has stored therein a program for causing a computer that is built in a server used for a printing system having connected thereto a plurality of printing apparatuses and an information processing apparatus having printer drivers corresponding to the plurality of printing apparatuses to execute the following steps. Namely, the print setting history display program of the second aspect includes: managing the plurality of printing apparatuses and acquiring, as print setting histories, contents of print setting at the time of performing printing by the printing apparatuses and information of documents subjected to printing processing; storing the acquired print setting histories; and classifying the stored print setting histories into groups satisfying predetermined conditions, generating display data for displaying, on a print setting screen of a selected printer driver, only the latest print setting history from among print setting histories classified into the same group satisfying predetermined conditions in the information processing apparatus, and transmitting the display data to the information processing apparatus. Other problems, configurations, and effects than those described above will be apparent through the description of the following embodiments.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a schematic view illustrating an overall configuration example of a printing system according to a first embodiment of the present invention;

FIG. 2 is a block diagram illustrating a hardware configuration example of a client terminal according to the first embodiment of the present invention;

FIG. 3 is a block diagram illustrating an example of a functional configuration of the client terminal according to the first embodiment of the present invention;

FIG. 4 illustrates an example of a print setting screen displaying a list of print setting histories according to the first embodiment of the present invention;

FIG. 5 is a flowchart of print setting history storage processing by a rendering processing unit (history storage processing unit) according to the first embodiment of the present invention;

FIG. 6 is a diagram illustrating an example of print job executed by a printing apparatus;

FIG. 7 is a diagram illustrating an example of print setting history data generated from the print job of FIG. 6;

FIG. 8 is a flowchart of history information generating processing for displaying a UI by a print setting UI unit (history display processing unit) according to the first embodiment of the present invention;

FIG. 9 is a flowchart of a UI display data (same document) generating processing performed by the print setting UI unit (history display processing unit) according to the first embodiment of the present invention;

FIG. 10 is an explanatory diagram relating to generation of UI display data (same document) and UI display data (same setting) according to the first embodiment of the present invention;

FIG. 11 is a flowchart of a UI display data (same setting) generating processing performed by the print setting UI unit (history display processing unit) according to the first embodiment of the present invention;

FIG. 12 is an example of UI display data (same document) according to the first embodiment of the present invention;

FIG. 13 is an example of UI display data (same setting) according to the first embodiment of the present invention;

FIG. 14 is an example of UI display data (master) according to the first embodiment of the present invention;

FIG. 15 is a diagram illustrating an example of normal display of a print setting screen (history display) according to the first embodiment of the present invention;

FIG. 16 is a diagram illustrating an example of a detailed display of the print setting screen (history display) according to the first embodiment of the present invention;

FIG. 17 is a block diagram illustrating main components of a functional configuration of a client terminal according to a second embodiment of the present invention;

FIG. 18 is a diagram illustrating an example of a print job executed by a first printing apparatus;

FIG. 19 is a diagram illustrating an example of a print job executed by a second printing apparatus;

FIG. 20 is an example of UI display data (master) of the first printing apparatus according to the second embodiment of the present invention;

FIG. 21 is an example of UI display data (master) of the second printing apparatus according to the second embodiment of the present invention;

FIG. 22 is a diagram illustrating an example of a print setting screen (history display) of a printer driver corresponding to the first printing apparatus according to the second embodiment of the present invention;

FIG. 23 is a diagram illustrating an exemplary print setting screen (history display) of the second printing apparatus according to the second embodiment of the present invention;

FIG. 24 is a block diagram illustrating an overall configuration of a printing system according to a third embodiment of the present invention;

FIG. 25 is a diagram illustrating an example in which a PCID is included in a print job of the first printing apparatus;

FIG. 26 is a diagram illustrating an example in which a PCID is included in a print job of the second printing apparatus; and

FIG. 27 is a diagram illustrating an example in which a user ID is included in a print job of the first printing apparatus.

### DESCRIPTION OF THE PREFERRED EMBODIMENTS

Hereinafter, an embodiment of the present invention will be described with reference to the drawings. However, the scope of the invention is not limited to the illustrated examples. Note that, in respective drawings, components having substantially identical functions or configurations are provided with identical reference numbers, and duplicate description thereof will be omitted.

### 1. First Embodiment

[Overall Configuration of Printing System]

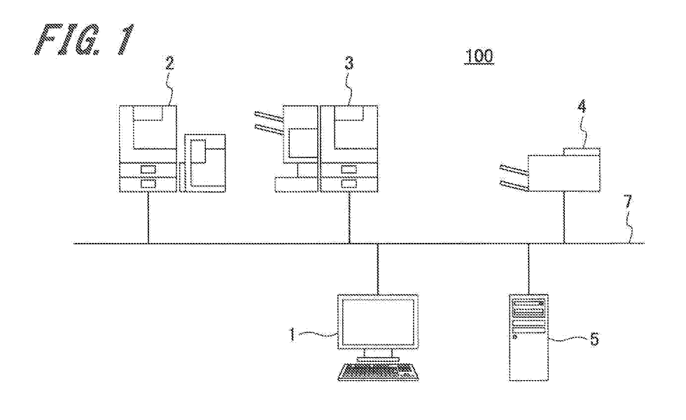

FIG. 1 is a schematic view illustrating an overall configuration example of a printing system according to a first embodiment of the present invention.

In a printing system 100 of FIG. 1, a client terminal which is a PC 1, printing apparatuses (image forming apparatuses) 2 to 4, and a server 5 are connected to a network 7 such as a LAN, and thus are communicably connected to each other via the network 7.

The PC 1, which is typically a personal computer, is an example of an information processing apparatus. In addition, a tablet terminal, a smartphone, or the like, may be used as an information processing apparatus.

The printing apparatuses 2 to 4 receive, via the network 7, print jobs output from the PC 1, and form and output images on sheets according to the contents of the print jobs (hereinafter, “printing processing”). The printing apparatuses 2 to 4 may be Multi Function Peripherals (MFPs) having a plurality of functions (print function, copying function, scanning function, FAX function, and the like).

The server 5 unitarily manages the printing apparatuses 2 to 4 connected to the network 7 as a single group. The number of printing apparatuses is not limited to three.

Note that data exchange between devices may be performed not via the network 7, but via a semiconductor memory such as a USB (Universal Serial Bus) memory.

[Hardware Configuration of Respective Devices]

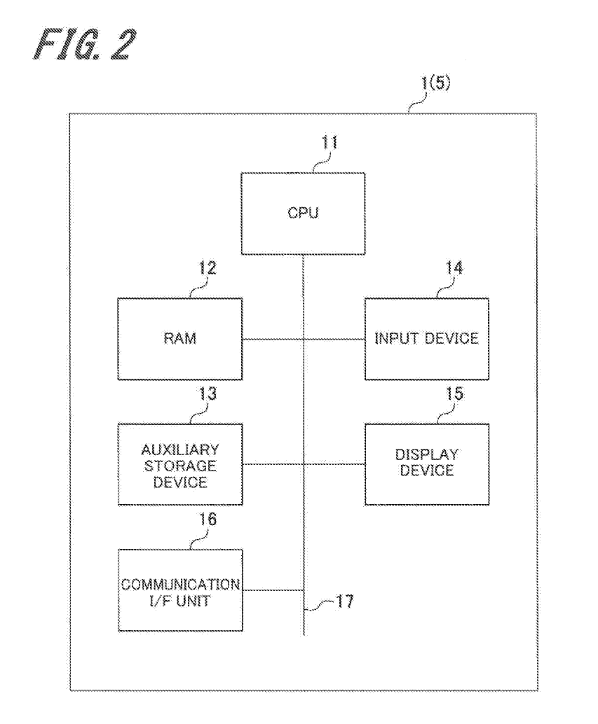

FIG. 2 is a block diagram illustrating a hardware configuration example of each device.

Here, a hardware configuration of a computer provided by the PC 1 and the server 5 constituting the abovementioned printing system 100 will be described. Note that each part illustrated in FIG. 2 is selected in accordance with the function or intended use of each device. Hereinafter, the PC 1 will be described.

The PC 1 includes a CPU (Central Processing Unit) 11, a volatile RAM (Random Access Memory) 12, and a nonvolatile auxiliary storage device 13, which are respectively connected to a bus 17. Furthermore, the PC 1 includes an input device 14, a display device 15, and a communication interface unit (“communication I/F” unit, in FIG. 2) 16.

The CPU 11 is a central processing unit which performs control of operation of the PC 1 as a whole and arithmetic processing, and reads, from the auxiliary storage device 13, program codes of software realizing respective functions according to the present embodiment and executes the codes. Note that the PC 1 may be provided with a processing device such as an MPU (Micro-Processing Unit) instead of the CPU 11.

The RAM 12 is a main memory device, and variables, parameters, or the like generated in the middle of arithmetic processing are temporarily written to the RAM 12.

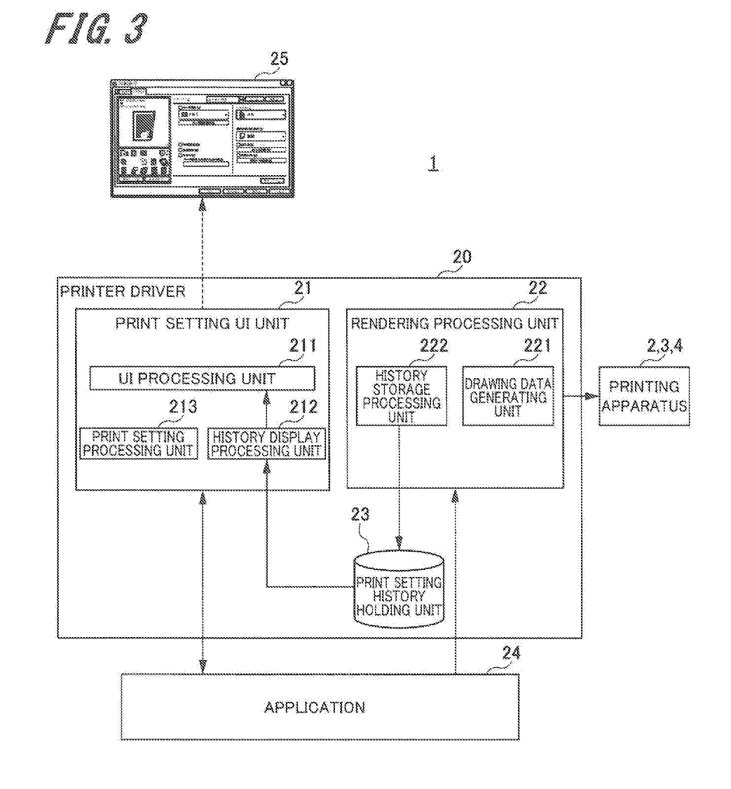

The auxiliary storage device 13, which is a storage device playing an auxiliary role of the RAM 12, has a mechanism that normally allows for storing data for a long time. There are used, as the auxiliary storage device 13, an HDD (Hard Disk Drive), an SSD (Solid State Drive), a flexible disk, an optical disk, an MO disk, a CD-ROM, a CD-R, a magnetic tape, a nonvolatile memory card, or the like. The auxiliary storage device 13 has recorded therein programs for allowing the PC 1 to function, in addition to the OS (Operating System) and various parameters. For example, the auxiliary storage device 13 has stored therein application software (hereinafter, referred to as “application”) 24 and a printer driver 20 (an example of print setting history display program) illustrated in FIG. 3.

There is used, as the input device 14, for example, a keyboard, a mouse, a touch panel or the like, through which the user can perform predetermined operations to input instructions. The display device 15 is, for example, a liquid crystal display monitor, and displays results of processing performed by the PC 1 or the like. A touch panel used as the input device 14 and a flat-panel display used as the display device 15 may be integrated by lamination, to thereby constitute an operation display panel.

In the communication I/F unit 16, there is used, for example, an NIC (Network Interface Card) or the like, and it is possible to transmit and receive various data between respective devices via the network 7 such as a LAN.

[Functional Configuration of PC]

FIG. 3 is a block diagram illustrating an example of a functional configuration of the PC 1.

In the PC 1, the application 24 stored in the auxiliary storage device 13, the printer driver 20, and the like are loaded to the RAM 12 when necessary to be processed by the CPU 11, and the processing result is displayed on the display device 15. The application 24 is, for example, document creating software, drawing software, a Web browser, a mailer, or the like.

The printer driver 20 includes a print setting UI unit 21 that provides the user with a print setting screen 25, a rendering processing unit 22 that converts print instructions from the application 24 into data which can be interpreted by the printing apparatus, and a print setting history holding unit 23.

The print setting UI unit 21 is constituted of a UI processing unit 211, a history display processing unit 212, and a print setting processing unit 213.

The UI processing unit 211 (an example of screen display processing unit) generates the print setting screen 25 as a user interface (UI) of the printer driver 20.

The history display processing unit 212 performs processing of classifying a plurality of print setting histories (print setting history records) stored in the print setting history holding unit 23 in accordance with predetermined conditions, and of creating history information for displaying the UI. In the present embodiment, UI display data (same document), UI display data (same setting), and UI display data (master) are generated as history information for displaying the UI. In addition, the history display processing unit 212 outputs each of the generated UI display data (master) to the UI processing unit 211.

The UI display data (same document) is a set of data having print setting histories of a corresponding printing processing classified into the same group when the same document has been subjected to printing processing a plurality of times with the contents of print setting changed. Only the print setting history of the final printing processing in each group is displayed on the print setting screen on the basis of the UI display data (same document).

The UI display data (same setting) is a set of data having print setting histories of the corresponding printing classified into the same group when printing processing has been performed in the same print setting as a print setting in the past. Only the print setting history of the latest printing in each group is displayed on the print setting screen on the basis of the UI display data (same setting).

The UI display data (master) is a result of merging the UI display data (same document) and the UI display data (same setting) into a single data set.

The print setting processing unit 213 performs processing of reflecting the contents of print setting in a print setting history selected by the user from the list of print setting histories of the print setting screen 25 to the print setting of the printer driver 20. Accordingly, it is possible to instruct printing by reflecting the contents of print setting used in the past to the current print setting of the printer driver 20.

The rendering processing unit 22 is constituted of a drawing data generating unit 221 and a history storage processing unit 222.

The drawing data generating unit 221 reflects the print setting to print data (document) of the application 24, converts the data (generates drawing data) into a language (PDL: Page Description Language) recognizable by the printing apparatus instructing the printing to thereby output the language. The language recognizable by the printing apparatus is PCL, PostScript or the like.

The history storage processing unit 222 stores, as print setting histories, the contents of print setting at the time of performing printing on the basis of print jobs, together with information of documents subjected to printing processing, in the print setting history holding unit 23 in chronological order. Information of the print jobs may be stored in the history storage processing unit 222.

The print setting history holding unit 23 is a location for storing data, such as the contents of print setting or information of documents, to be used for displaying print setting histories. The print setting history holding unit 23 is provided in the auxiliary storage device 13.

[Print Setting Screen]

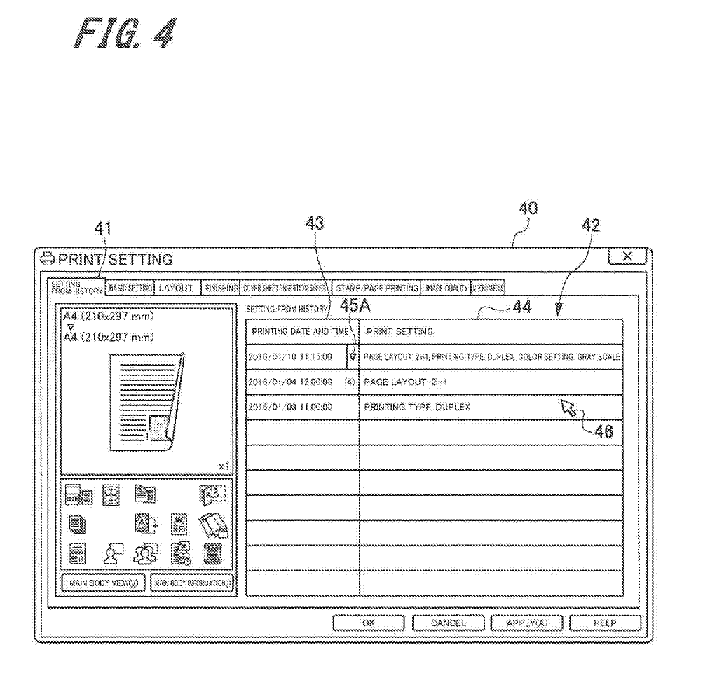

FIG. 4 is a diagram illustrating an example of a print setting screen displaying a list of print setting histories.

A print setting screen 40 illustrated in FIG. 4 includes a plurality of tabs for each group of functions, and has, for example, a “setting from history” tab 41, a “basic setting” tab, or the like. Selection of the “setting from history” tab 41 causes a list of print setting histories 42 to be displayed. The list of print setting histories 42 has “printing date and time” and “print setting” as fields constituting a record.

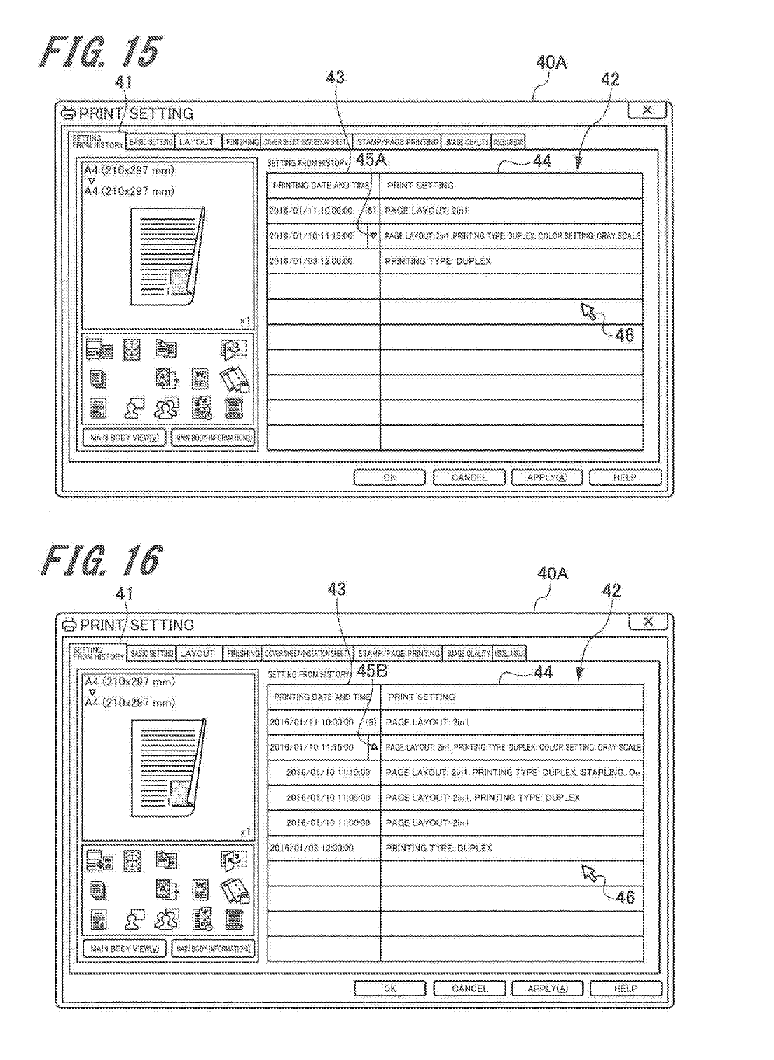

In the printing date-and-time field 43, the print setting history having a downward arrow mark 45A (▾ symbol), which is a detailed display indicator displayed thereon, is a history in which the same document has been output a plurality of times within a certain time period with the print setting changed. A pull-down list (see FIG. 16) is displayed by movement of a pointer 46 to the position of the downward arrow mark 45A and clicking of the mark through the use of the input device 14.

The numerical value “2016/01/04 12:00:00 (4)” shown in parentheses in the printing date-and-time field 43 is the number of times for which printing has been executed in the same print setting. Display of the print setting screen 40 described above is performed by the UI processing unit 211 of the print setting UI unit 21.

[Print Setting History Storage Processing]

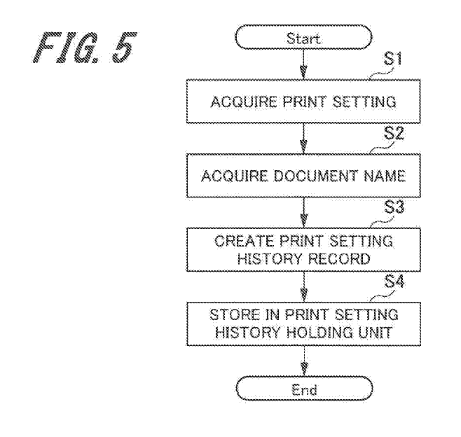

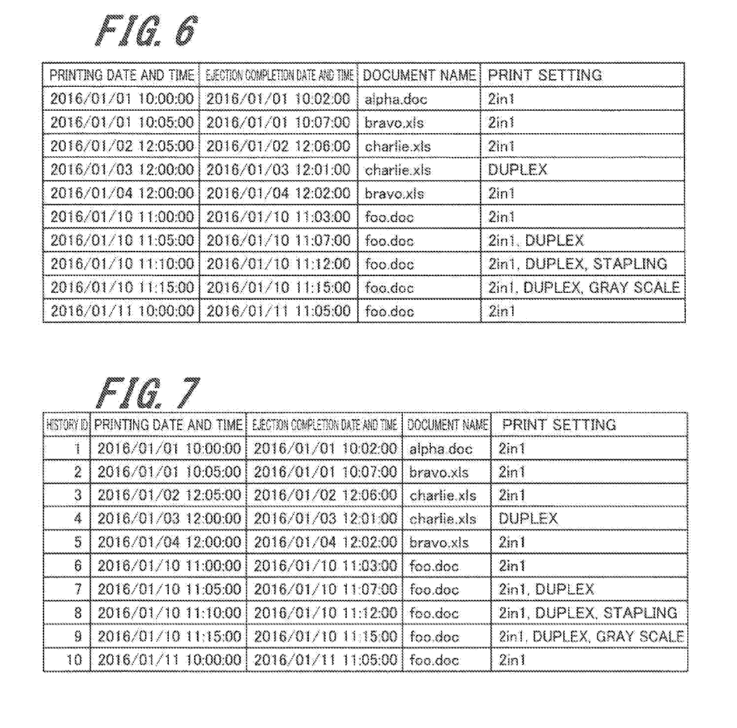

FIG. 5 is a flowchart of a print setting history storage processing by the rendering processing unit 22 (history storage processing unit 222). The print setting history storage processing of FIG. 5 is realized by reading and execution of a program from the auxiliary storage device 13 by the CPU 11. The same also applies to FIGS. 6, 7 and 9 described below.

First, the history storage processing unit 222, upon receiving a print instruction from the application 24, acquires the contents of the print setting and the name of the document (document name) to be printed (S1, S2).

The document to be printed may be any of directly or indirectly specified documents. Indirect specifying refers to, for example, automatically specifying, as a target of printing, a document file, or the like attached to a mailer, or automatically specifying, as a target of printing, a web page, a data file, or the like of a link destination indicated by a URL (Uniform Resource Locator) displayed on a Web page.

Next, the history storage processing unit 222 creates a print setting history record including the contents of print setting acquired at steps S1 and S2 and the document name (S3), and stores the record in the print setting history holding unit 23 (S4). Upon completion of the processing of step S4, the present flowchart is terminated.

[Example of Print Job]

FIG. 6 illustrates an example of a print job executed by the printing apparatus. The print job has fields of “printing date and time”, “ejection completion date and time”, “document name”, and “print setting”, as an example.

The printing date and time is the date and time when printing processing is instructed by the printer driver, and the ejection completion date and time is the date and time when the print job is executed and a printed matter (sheet) is ejected. In addition, the document name is the name of the document subjected to printing processing, and the print setting is the setting when performing the printing processing.

[Example of Print Setting History Data]

FIG. 7 illustrates print setting history data generated from the print job of FIG. 6.

The print setting history data of FIG. 7 has a “history ID” given to the record constituting the print job. The history ID is unique identification information assigned every time printing is performed, and includes numbers, characters, or the like. In the example of FIG. 7, numbers starting from one are assigned in order of each record generation (order of printing date and time) as the history ID.

[History Information Generating Processing]

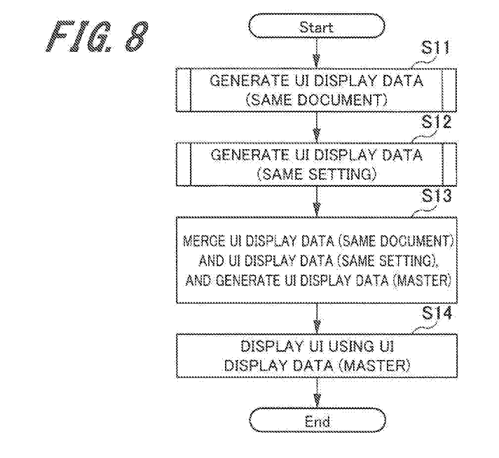

FIG. 8 is a flowchart of history information generating processing for displaying a UI by the print setting UI unit 21 (the history display processing unit 212). The UI processing unit 211 displays the list of print setting histories 42 on the print setting screen, by using the UI display data (master) generated by the history information generating processing of FIG. 8.

The history display processing unit 212 first generates UI display data (same document) from the print setting history data illustrated in FIG. 7 (S11). The processing of step S11 is a task of classifying the print setting history records of the print setting history data into the same group satisfying the same-document condition.

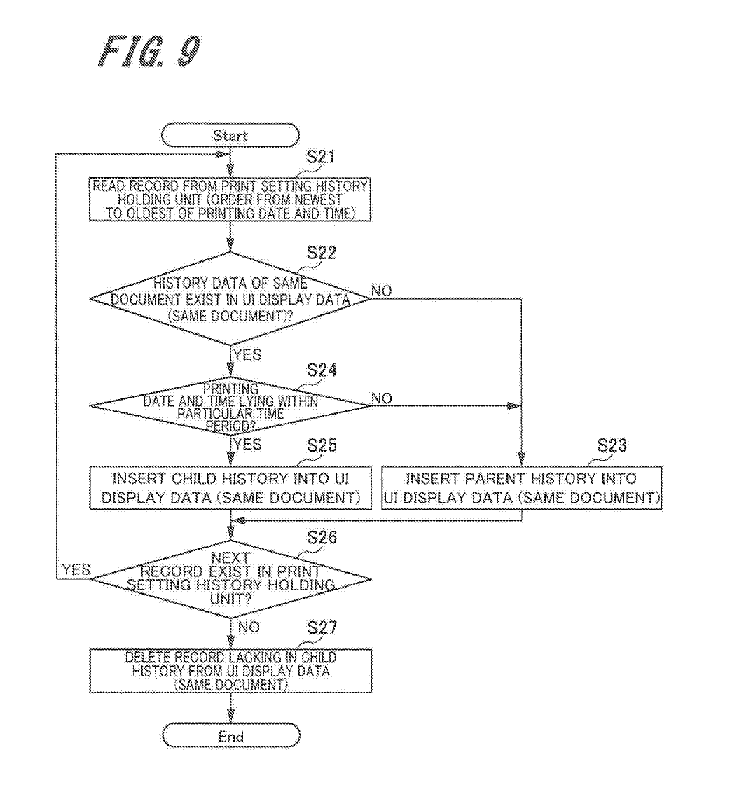

Subsequently, the history display processing unit 212 generates UI display data (same setting) from the print setting history data (S12). The processing of step S12 is a task of classifying the print setting history records of the print setting history data into the same group satisfying the same-print-setting condition. A specific method of generating the UI display data (same document) and the UI display data (same setting) will be described below with reference to FIGS. 9 to 13.

Next, the history display processing unit 212 integrates (merges) the UI display data (same document) and the UI display data (same setting) into a single data set, and generates the UI display data (master) as illustrated in FIG. 14 described below (S13).

Then, the UI processing unit 211 displays the print setting screen as a UI, by using the UI display data (master) generated by the history display processing unit 212 (S14). Upon completion of the processing of step S14, the present flowchart is terminated.

As thus described, in the history information generating processing for displaying the UI, the history information for the same document and the history information for the same print setting are separately generated and thereafter merged to thereby generate the UI display data of the master.

[UI Display Data (Same Document) Generating Processing]

Next, a UI display data (same document) generating processing at step S11 of FIG. 8 will be described.

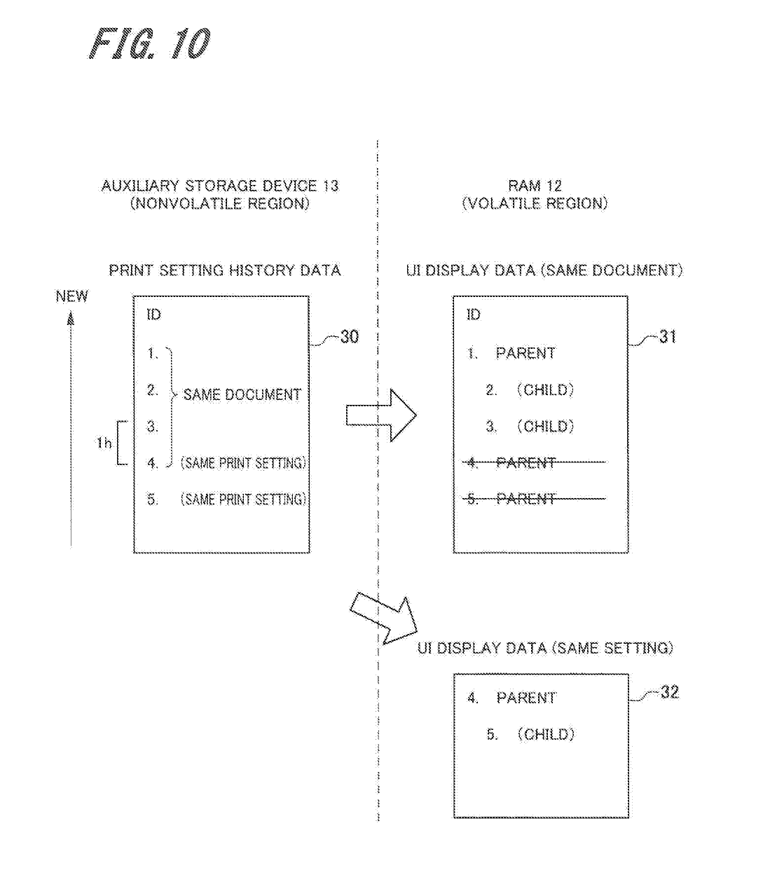

FIG. 9 is a flowchart of a UI display data (same document) generating processing performed by the print setting UI unit 21 (the history display processing unit 212). FIG. 10 is an explanatory diagram relating to generation of the UI display data (same document) and the UI display data (same setting).

Print setting history data 30 illustrated on the left-hand side of FIG. 10 records all the print setting history records within a certain time period, and the smaller the history ID is, the newer the printing date and time is. In the present example, there are, for example, five print setting history records. The print setting history records of the print setting history data 30 with the history IDs ‘1’ to ‘4’ are assumed to print the same document, respectively, with different print settings. Although the printing dates and times of the print setting history records with the history IDs ‘3’ and ‘4’ are separated from each other by one hour, the interval between the printing dates and times of other print setting history records is assumed to be five minutes. In addition, the print setting history records with the history the IDs ‘4’ and ‘5’ use the same print setting. Each of the five print setting history records is classified into either UI display data (same document) 31 or UI display data (same setting) 32 at the right-hand side of FIG. 10. Note that, in FIG. 10, the history ID is simply denoted as ‘ID’.

In FIG. 9, the history display processing unit 212 first reads a print setting history record of the print setting history data 30 from the print setting history holding unit 23 (S21) into the RAM 12. Reading of the print setting history record is performed in order from the newest of the printing date and time.

Next, the history display processing unit 212 determines whether or not history data (print setting history record) of the same document as that of the read-in print setting history record exists in the UI display data (same document) 31 (S22). Here, when print setting history record of the same document does not exist (NO at S22), the history display processing unit 212 inserts the print setting history record into the UI display data (same document) 31 as a parent history (S23).

By taking the print setting history data 30 of FIG. 10 as an example, the print setting history record with the history ID ‘1’ has the newest printing date and time, and thus no print setting history record exists in the UI display data (same document) 31. Accordingly, the print setting history record with the history ID ‘1’ is stored in the UI display data (same document) 31 as a parent history.

Subsequently, the history display processing unit 212 determines whether or not a next print setting history record exists in the print setting history holding unit 23 (the print setting history data 30) (S26). Then, when there exists a next print setting history record (YES at S26), the history display processing unit 212 reads the next print setting history record from the print setting history holding unit 23, and determines the presence or absence of a print setting history record of the same document (S21, S22).

For example, the document of the print setting history record with the history ID ‘2’ is the same as the document of the print setting history record with the history ID ‘1’. Accordingly, the history display processing unit 212 determines that history data (print setting history record with the history ID ‘1’) of the same document as that of the print setting history record with the history ID ‘2’ exists in the UI display data (same document) 31 (YES at S22).

Next, the history display processing unit 212 determines whether or not the printing dates and times of two print setting history records for the same document are within a particular time period (S24). In a case where they are within a particular time period (YES at S24), the print setting history record is inserted into the UI display data (same document) 31, as a child history (S25).

When the particular time period is, for example, 10 minutes, the printing dates and times of the print setting history records with the history IDs ‘1’ and ‘2’ are within a particular time period on (a five-minute interval). Therefore, the print setting history record with the history ID ‘2’ is stored in the UI display data (same document) 31 as a child history of the print setting history record with the history ID ‘1’ (FIG. 10).

In addition, when there exists a further next print setting history record (YES at S26), the history display processing unit 212 reads the next print setting history record, and determines the presence or absence of a print setting history record of the same document and whether or not the printing date and time is within a particular time period (S21, S22, S24).

For example, the document of the print setting history record with the ID ‘3’ is the same as the document of the print setting history record with the history ID ‘1’, and also their printing dates and times are within a particular time period. Therefore, the print setting history record with the history ID ‘3’ is stored in the UI display data (same document) 31, as a child history of the print setting history record with the history ID ‘1’ (FIG. 10).

Although the document of the print setting history record with the history ID ‘4’ is the same as the document of the print setting history record with the history ID ‘1’, the time difference from the preceding printing date and time is one hour, and thus the history display processing unit 212 determines that their printing dates and times are not within a particular time period (NO at S24). Then, the history display processing unit 212 inserts the print setting history record with the history ID ‘4’ into the UI display data (same document) 31 as a parent history (FIG. 10).

In the print setting history record with the history ID ‘5’, there exists no print setting history record having the same document, and thus the print setting history record with the history ID ‘5’ is inserted into the UI display data (same document) 31 as a parent history (FIG. 10).

Finally, when a next print setting history record does not exist in the print setting history holding unit 23 (NO at S26), the history display processing unit 212 deletes the print setting history record lacking in a child history from the UI display data (same document) 31 (S27). Upon completion of the processing of step S27, the history display processing unit 212 terminates the present flowchart.

Through the processing as described above, the print setting history records with the history IDs ‘1’ to ‘3’ in the UI display data (same document) 31 are classified into the same group having a parent-and-child relation under the same-document condition. On the other hand, there is no child history for the print setting history records with the history IDs ‘4’ and ‘5’, and thus the print setting history records with the history IDs ‘4’ and ‘5’ are deleted.

The particular time period at step S24 described above may be able to be arbitrarily set by the user via the input device 14. The shorter the particular time period is, the more likely it is that there exists some correlation (there exists relevance) between print setting histories generated within the set time period.

In addition, it is assumed that the particular time period does not include the time taken to perform printing processing by the printing apparatus. The time taken to perform printing processing by the printing apparatus refers to the time required from the time when a user presses a print button (icon) displayed on the UI (corresponding to the printing date and time) to the time when ejection is completed. For example, accumulation of print jobs may result in delayed reception of a print job which is transmitted later, and thus there is a case where it takes a long time until the print job is executed. In such a case, even when the interval between the printing dates and times of successive print setting histories is one hour, the interval between the printing dates and times of two print setting histories is considered to be one minute if the time taken to complete ejection in the preceding print setting history is 59 minutes. Accordingly, classification of print setting histories can be performed more accurately by calculation of the time difference between the printing dates and times of the two print setting histories through exclusion of the time taken for completing ejection, and by comparison of the time difference of the printing date and time with the particular time.

Note that, at step S27, in a case where a print setting history record has the same document as that of its parent history print setting history record and where both records have the same print setting and print times and dates within a particular time period, the relevant print setting history record may be deleted. Accordingly, it is possible to delete a print setting history record having duplicate setting content, and then to insert the latest print setting history record into the UI display data (same document).

[UI Display Data (Same Setting) Generating Processing]

Next, a UI display data (same setting) generating processing at step S12 of FIG. 8 will be described.

FIG. 11 is a flowchart of a UI display data (same setting) generating processing performed by the print setting UI unit 21 (the history display processing unit 212). The flowchart of FIG. 11 will be described with reference to FIG. 10.

First, the history display processing unit 212 first reads a print setting history record of the print setting history data 30 from the print setting history holding unit 23 into the RAM 12 in in order from the newest of the printing date and time (S31). The processing is similar to that of step S21 of FIG. 9.

Subsequently, the history display processing unit 212 determines whether or not the read-in print setting history record exists in the parent history or the child history of the UI display data (same document) 31 (S32). Here, when the read-in print setting history record exists in the parent history or the child history (YES at S32), the history display processing unit 212 determines whether or not a next print setting history record exists in the print setting history holding unit 23 (the print setting history data 30) (S36).

Subsequently, when there exists a next print setting history record (YES at S36), the history display processing unit 212 reads the next print setting history record from the print setting history holding unit 23, and determines whether or not the read-in print setting history record exists in the parent history or the child history (S31, S32).

In the example of FIG. 10, the print setting history records with the history IDs ‘1’ to ‘3’ of the print setting history data 30 exist in the UI display data (same document) 31, and thus processing of steps S31, S32 and S36 is repeated.

In addition, when the read-in print setting history record does not exist in the parent history or the child history of the UI display data (same document) (NO at S32), the history display processing unit 212 determines whether or not a history data (print setting history record) having the same print setting as the read-in print setting history record exists in the UI display data (same setting) 32 (S33).

Here, when a print setting history record having the same print setting does not exist (NO at S33), the history display processing unit 212 inserts the print setting history record into the UI display data (same setting) 32 as a parent history (S34). On the other hand, when a print setting history record with the same print setting exists (YES at S33), the history display processing unit 212 inserts the print setting history record into the UI display data (same setting) as a child history (S35).

Then, upon completion of the processing of step S34 or 35, the history display processing unit 212 determines whether or not a next print setting history record exists in the print setting history holding unit 23 (the print setting history data 30) (S36). The history display processing unit 212 terminates the present flowchart when there is no next print setting history record (NO at S36).

By taking the print setting history data 30 of FIG. 10 as an example, there is no print setting history record at all in the UI display data (same setting) 32 before the history ID ‘4’. Accordingly, the print setting history record with the history ID ‘4’ is stored as a parent history in the UI display data (same setting) 32.

The print setting history record with the history ID ‘5’ has the same print setting as that of the print setting history record with the history ID ‘4’. Accordingly, the print setting history record with the history ID ‘5’ is stored in the UI display data (same setting) 32 as a child history of the print setting history record with the history ID ‘4’. As thus described, the print setting history records with the history IDs ‘4’ and ‘5’ in the UI display data (same setting) 32 are classified into the same group having the parent and child relation under the same-print-setting condition.

[Example of UI Display Data (Same Document)]

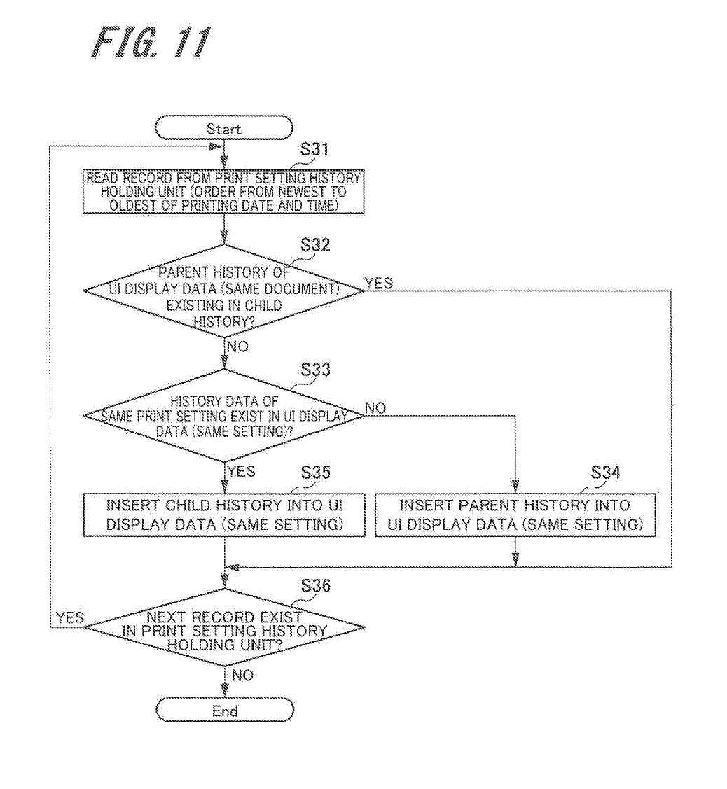

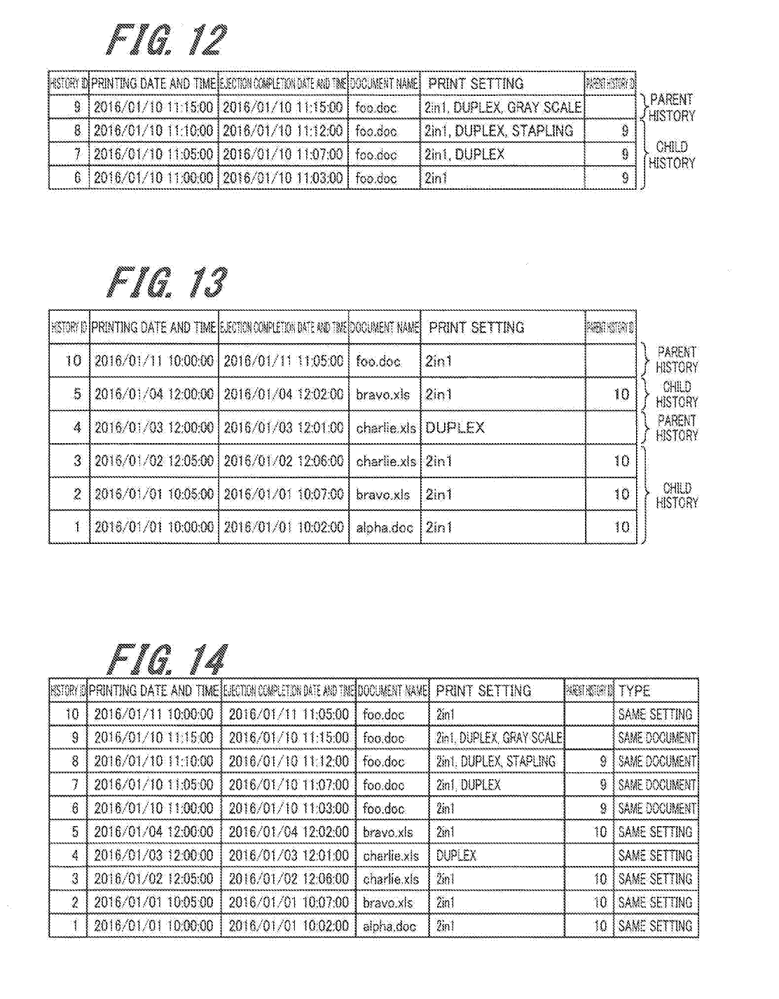

FIG. 12 illustrates UI display data (same document) generated from the print setting history data of FIG. 7.

The UI display data (same document) of FIG. 12 has a “parent history ID” field in addition to the print setting history data of FIG. 7. Distinction between a parent history and a child history is determined by the presence or absence of an ID in the parent history ID field. When there is no ID in the parent history ID field of a certain print setting history record, the print setting history record is a parent history, or, when there exists an ID, the print setting history record is a child history having the print setting history record of the described ID as its parent history.

When the same document has been output a plurality of times within a particular time period with the setting changed, the present embodiment treats the print setting history record corresponding to the finally output print job as a parent history, and older print setting history records printed within a particular time period as child histories. In the example of FIG. 12, print setting history records including the document name ‘foo.doc’ are classified into the same group, in which the print setting history record with the history ID ‘9’ is the parent history, and print setting history records with the history IDs ‘8’ to ‘6’ are child histories.

[Example of UI Display Data (Same Setting)]

FIG. 13 illustrates UI display data (same setting) generated from the print setting history data of FIG. 7.

The UI display data (same setting) of FIG. 13 also has a “parent history ID” field in addition to the print setting history data of FIG. 7. Distinction between a parent history and a child history is determined by the presence or absence of an ID in the parent history ID field, similarly to the case of the same document of FIG. 12.

When there has been a plurality of times of outputs in the same print setting, the present embodiment treats the print setting history record corresponding to the finally output print job as a parent history, and the other older print setting history records as child histories.

In the example of FIG. 13, print setting history records with the history IDs ‘10’, ‘5’ and ‘3’ to ‘1’ including the print setting ‘2in1’ are classified into the same group, in which the print setting history record with the history ID ‘10’ is a parent history, and the print setting history records with the history IDs ‘5’ and ‘3’ to ‘1’ are child histories. In addition, the print setting history record with the history ID ‘4’ having the print setting of ‘duplex’ is a parent history without any child history.

Note that, although the print setting history records with the history IDs ‘5’ and ‘2’ have the same document name ‘bravo.xls’, since their print settings are the same with ‘2in1’, they are classified into a group of the same setting. The print setting history records with the history IDs ‘5’ and ‘2’ are not classified into a group of the same document due to the long interval (three days) between their printing dates and times.

Setting items to be compared when performing classification into a group under the same-print-setting condition are all the setting items described in the print setting field of the print setting history records. When all the setting items included in two print setting history records match, the history display processing unit 212 determines that the two are of the same print setting. For example, candidates of setting items include page layout (2in1, 4in1), printing type (duplex, simplex), color setting (automatic color, gray scale, two colors, etc.), post-processing function (stapling, binding, folding, etc.), number of copies, document size, document (print) orientation, or the like.

In addition, setting items to be compared when performing classification into a group under the same-print-setting condition may have arbitrary setting items excluded from all the setting items described above. In a case where the abovementioned comparison method is perfect matching, the present method is partial matching. The arbitrary setting items to be excluded are assumed to include at least any one of: number of copies, document size, or document (print) orientation, for example. The setting items are those which can be specified in the application 24, or those with an invariable relationship between sheets and print data such as the number of copies.

In addition, arbitrary setting items can be specified as the setting items to be compared when performing classification into the group described above. Here, the arbitrary setting items can be assumed to include at least any one of: page layout, printing type, color setting, or post-processing function.

[Example of UI Display Data (Master)]

FIG. 14 illustrates UI display data (master) generated from the UI display data (same document) of FIG. 12 and the UI display data (same setting) of FIG. 13.

The UI display data (master) of the present embodiment is generated by merging the UI display data (same document) of FIG. 12 and the UI display data (same setting) of FIG. 13 into a single data set, and is sorted by the printing date and time. The printing date and time after sorting is in descending order. The UI display data (master) has a “type” field in addition to the UI display data of FIGS. 12 and 13. The type field is provided with information for distinguishing histories of the same document or histories of the same print setting. In the example of FIG. 14, the type field of the print setting history records with the history IDs ‘10’ and ‘5’ to ‘1’ is provided with ‘same setting’, and the type field of the print setting history records with the history IDs ‘9’ to ‘6’ is provided with ‘same document’.

The parent history ID is utilized for the following applications when displaying a list of print setting histories.
count of the number of times of having performed printing in the same print setting
association between histories in also displaying also print setting histories (child histories) other than the print setting history (parent history) when being subjected to final printing processing in the same group, in a case where the same document has been output a plurality of times within a particular time period with the setting changed.

[Example of Print Setting Screen (Normal Display)]

FIG. 15 illustrates an example of normal display of a print setting screen (history display). The list of print setting histories 42 of a print setting screen 40A of FIG. 15 is an example of being displayed on the basis of the UI display data (master) of FIG. 14.

The list of print setting histories 42 of the print setting screen 40A has three print setting histories displayed therein. The print setting history having “2016/01/11 10:00:00 (5)” displayed in a printing date-and-time field 44 corresponds to the print setting history record with the history ID ‘10’. The numerical value in the parenthesis indicates the total number of print setting histories having the same print setting classified into the same group, in a case where printing has been performed a plurality of time in the same print setting. In addition, the print setting history with the printing date and time “2016/01/10 11:15:00” corresponds to the print setting history record with the history ID ‘9’. Additionally, the print setting history with the printing date and time “2016/01/03 12:00:00” corresponds to the print setting history record with the history ID ‘4’.

As illustrated in FIG. 15, there are two display forms of the print setting screen 40A as follows.

(a) In a case where printing processing has been performed with the same print setting as past print setting, only the latest print setting history is displayed without displaying the past print setting histories.

(b) In a case where the same document has been output a plurality of times within a particular time period with the print setting changed, only the print setting history of the final output is displayed. Namely, when the same document has been output a plurality of times within a short time period with the print setting changed, the final print setting is determined to be correct.

The downward arrow mark 45A is a detailed display indicator that also displays the details of the corresponding print setting histories, i.e., those other than the print setting history when a corresponding document in the same group is finally subjected to printing processing (preceding print setting histories).

[Example of Print Setting Screen (Detailed Display)]

FIG. 16 illustrates an example of a detailed display of a print setting screen (history display). FIG. 16 is an example of also displaying, on the print setting screen 40A of FIG. 15, print setting histories other than the finally set print setting history among print setting histories in which the same document has been output a plurality of times within a particular time period with the print setting changed.

A pull-down list of the print setting screen 40A of FIG. 16 is displayed by movement of the pointer 46 to the position of the downward arrow mark 45A of FIG. 15 and clicking of the mark through the use of the input device 14.

An upward arrow mark 45B (A symbol) is used in order to close the pull-down list and display the print setting history which has been finally set in the same group.

The print setting screen 40A of FIG. 16 has three child history print setting history records other than the parent history displayed thereon as a pull-down list. The print setting history with the printing date and time “2016/01/10 11:10:00” corresponds to the print setting history record with the history ID ‘8’, the print setting history with the printing date and time “2016/01/10 11:05:00” corresponds to the print setting history record with the history ID “7”, and the print setting history with the printing date and time “2016/01/10 11:00:00” corresponds to the print setting history record with the history ID ‘6’.

As thus described, also displaying of print setting histories other than the finally set print setting history among print setting histories of the same document allows the user to also refer to print setting histories other than the finally set print setting history.

Note that, in the detailed display of FIG. 16, when there are print setting history records having the same document and the same print setting as the print setting history record serving as a parent history, and also falling within a particular time period, it is also conceivable to display, in a parenthesis, the number of the pertinent print setting history records. Although in the explanation of FIG. 9, the deletion of the pertinent print setting history records has been decided, displaying of such a number allows for knowing which document has been output how many times and in what kind of print setting.

### Effect of First Embodiment

According to the first embodiment described above, only the latest print setting history (parent history) is displayed from among a plurality of print setting histories classified into the same group (parent and child relation) satisfying predetermined conditions (same document or same print setting). Accordingly, the number of print setting histories displayed in the list of print setting histories on the print setting screen is reduced. Therefore, it is possible to enhance the search characteristics when a user is searching for a desired print setting from a list of print setting histories.

For example, in a case where the same document has been output a plurality of times within a particular time period with the print setting changed, it is possible to present a print setting that is considered to have a higher probability of being desired by the user, by displaying only the print setting history of the final output. Note that, in a case where the same document has been output within a particular time period with the print setting changed, although it is conceivable that the user has very likely changed the print setting with some intention, this is not essential, and the “within a particular time period” condition may be excluded when forming a group with the same print setting.

Furthermore, as illustrated in FIG. 16, a mechanism for allowing a user to also refer to print setting histories other than the print setting history of the final output enables the user to check the past print settings for the same document, as necessary. Accordingly, the user can search for a former print setting or the like the user is accustomed to use, besides the latest print setting. Therefore, the present embodiment provides the user with ease of use when performing a search.

Additionally, in a case where printing processing has been performed with the same print setting as a past print setting, the user can recognize the latest print setting used, by classifying the print setting histories of respective printing processing into the same group and by displaying only the print setting history of the latest printing processing.

Furthermore, in a case where printing has been performed a plurality of times in the same print setting, the user can recognize the frequency of the print setting being used, as a reference for performing print setting this time, by displaying the number of print setting histories having the same print setting classified into the same group.

### 2. Second Embodiment

A second embodiment is an example in which a client terminal is provided with a plurality of printer drivers, and uses print setting histories when performing printing by the use of a plurality of different printer drivers.

[Schematic Configuration of Printing System]

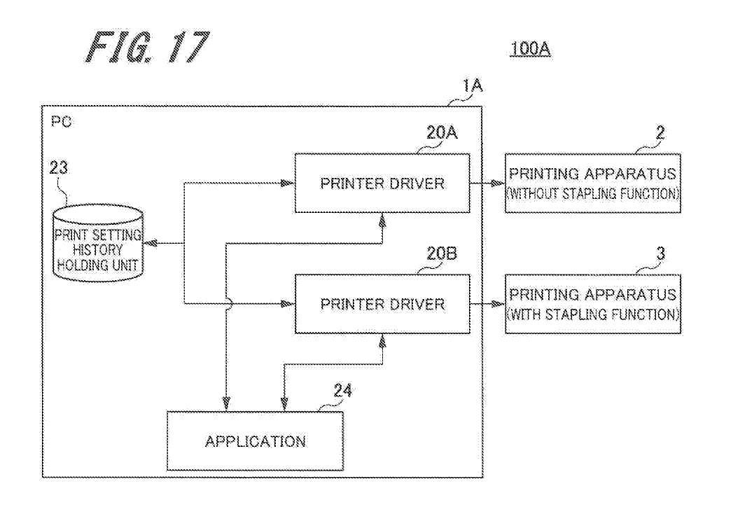

FIG. 17 is a block diagram illustrating main components of a functional configuration of a client terminal according to the second embodiment. The block diagram of FIG. 17 has described therein components considered necessary for explaining the second embodiment, and explanation of parts duplicated with the respective drawings of the first embodiment is omitted in FIG. 17. Although the printing apparatus 4 of FIG. 1 is excluded in FIG. 17 for ease of explanation, the number of printing apparatuses may be three or more, without being limited to the example.

A client terminal such as a PC 1A, constituting a printing system 100A of FIG. 17 is provided with printer drivers 20A and 20B. The printer driver 20A is an example of a first printer driver, and the printer driver 20B is an example of a second printer driver. The printer driver 20A is connected to the printing apparatus 2 (an example of the first printing apparatus), and the printer driver 20B is connected to a printing apparatus 3 (an example of the second printing apparatus). The printing apparatus 2 does not have a stapling function, but the printing apparatus 3 has a stapling function. The printer drivers 20A and 20B hold information relating to the functions of print apparatuses 2 and 3, and display, on the print setting screen, setting items which can be set in accordance with the functions of the printing apparatuses 2 and 3 which instruct printing.

The PC 1A is provided with a hardware configuration similar to the PC 1 of FIG. 2. The internal configuration of each of the printer drivers 20A and 20B is similar to the printer driver 20 described in FIG. 3. In the PC 1A, a program stored in the auxiliary storage device 13 (FIG. 2) is loaded to the RAM 12 as necessary and processed by the CPU 11, and the result of processing is displayed on the display device 15.

The print setting history holding unit 23 is arranged at a position where the printer drivers 20A and 20B in the PC 1A can refer to. The printer drivers 20A and 20B store, as a print setting history, the contents of print setting when printing has been instructed by the printer drivers 20A and 20B, and information of the document subjected to printing processing, in the print setting history holding unit 23.

The history display processing unit 212 (FIG. 3) of the printer drivers 20A and 20B classifies the print setting histories stored in the print setting history holding unit 23 into groups satisfying predetermined conditions (same document, same print setting), and generates, for each printer driver, UI display data (master) reflecting the classification result.

In addition, the UI processing unit 211 of the printer drivers 20A and 20B performs processing of displaying only the latest print setting history from among print setting histories classified into the same group on the basis of the UI display data (master) generated for each printer driver when displaying, on the print setting screen of the selected printer driver, a list of print setting histories stored in the print setting history holding unit 23.

Then, the print setting processing unit 213 of the printer drivers 20A and 20B performs a print setting on the basis of the print setting history selected from the list of print setting histories displayed on the print setting screen.

Note that each of the printer drivers 20A and 20B may have the history display processing unit 212 for its own use, or the printer drivers 20A and 20B may share the history display processing unit 212. When sharing the history display processing unit 212, the history display processing unit 212 outputs, to each printer driver, the UI display data (master) for displaying the list of print setting histories 42 on the print setting screen of the selected printer driver.

[Examples of Print Jobs of Printing Apparatuses]

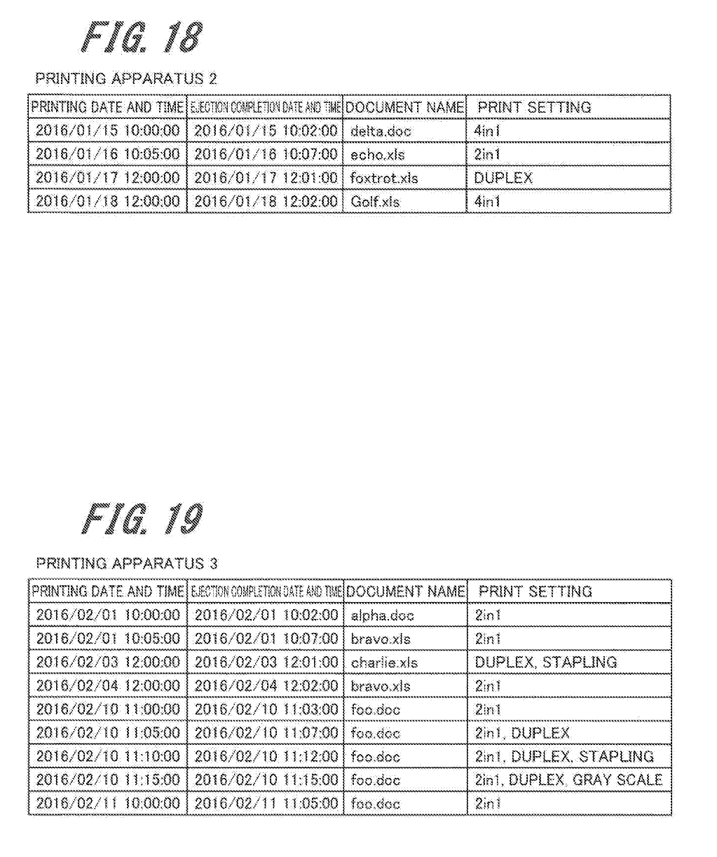

Here, examples of print jobs executed by respective printing apparatuses will be described. FIG. 18 is an example of a print job executed by the printing apparatus 2, and FIG. 19 is an example of a print job executed by the printing apparatus 3.

In FIG. 18, histories of four print jobs are recorded. FIG. In FIG. 19, histories of nine print jobs are recorded. In the histories of print jobs, there are included two histories including the setting information about stapling which is one of the post-processing functions.

[Example of UI Display Data (Master) of Printing Apparatus]

Next, an example of UI display data (master) generated on the basis of respective print jobs described above will be shown. FIG. 20 is an example of UI display data (master) of the printing apparatus 2 generated on the basis of the print jobs of FIGS. 18 and 19, and FIG. 21 is an example of UI display data (master) of the printing apparatus 3 generated on the basis of the print jobs of FIGS. 18 and 19. The UI display data (master) illustrated in FIGS. 20 and 21 is generated by the history display processing unit 212.

The UI display data (master) illustrated in FIGS. 20 and 21 is configured such that a “display/non-display” field is added to the UI display data (master) of FIG. 14. In FIGS. 20 and 21, the history IDs ‘101’ to ‘104’ are assigned to a print setting history record corresponding to the printing apparatus 2, and the history IDs ‘201’ to ‘209’ are assigned to a print setting history record corresponding to the printing apparatus 3.

In the second embodiment, setting of “non-display” is performed on a print setting history record including setting information for a function which is not supported by the printing apparatus in the UI display data (master) generating processing of the flowchart of FIG. 8. In the example, the stapling function is not provided in the case of the printing apparatus 2 (FIG. 20) and thus setting of “non-display” is performed on the print setting history records with the history IDs ‘207’ and ‘203’ including setting information of stapling. The printing apparatus 3 has the stapling function, and thus setting of “non-display” is not performed on all of the print setting history records of FIG. 21.

Functions that are not supported by the printing apparatuses 2 and 3 include, besides the functions that are not installed in the printing apparatuses 2 and 3, functions unavailable for some reason in a current state of the printing apparatuses 2 and 3. There are included cases of, for example, running out of stapler needles, not being capable of color printing without replenishing color toner, and the like.

The printer drivers 20A and 20B hold information of functions which are available and functions which have turned unavailable, in the corresponding printing apparatuses 2 and 3.

[Example of Print Setting Screen (1)]

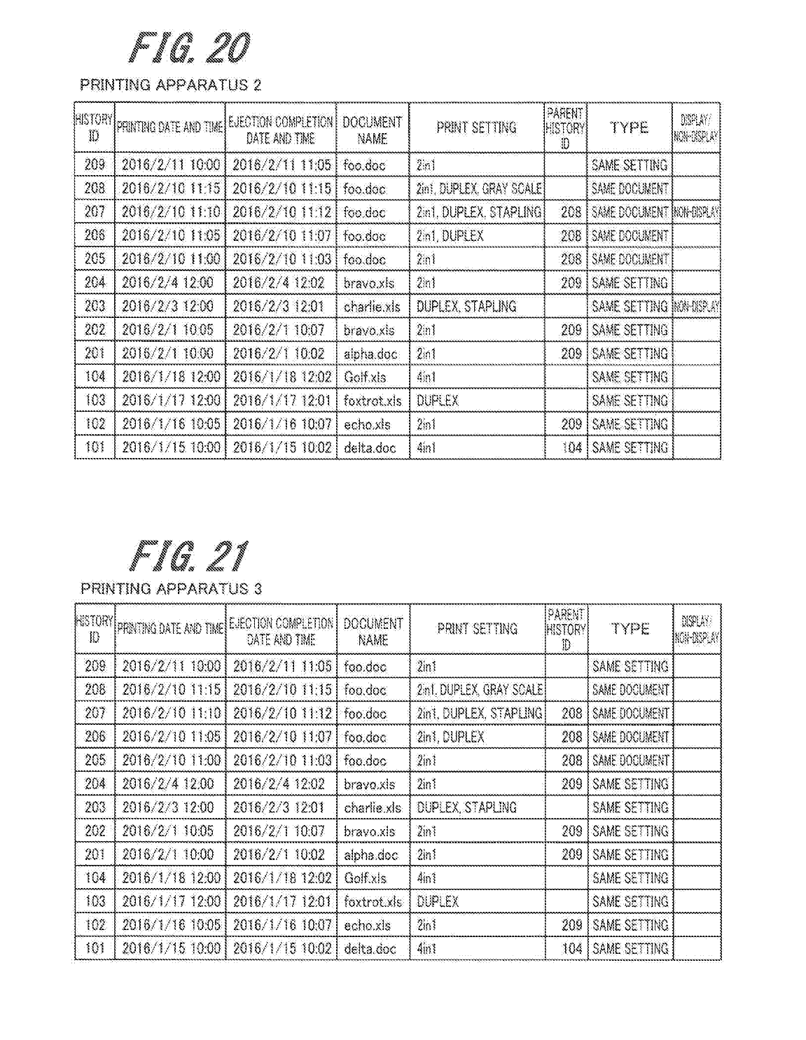

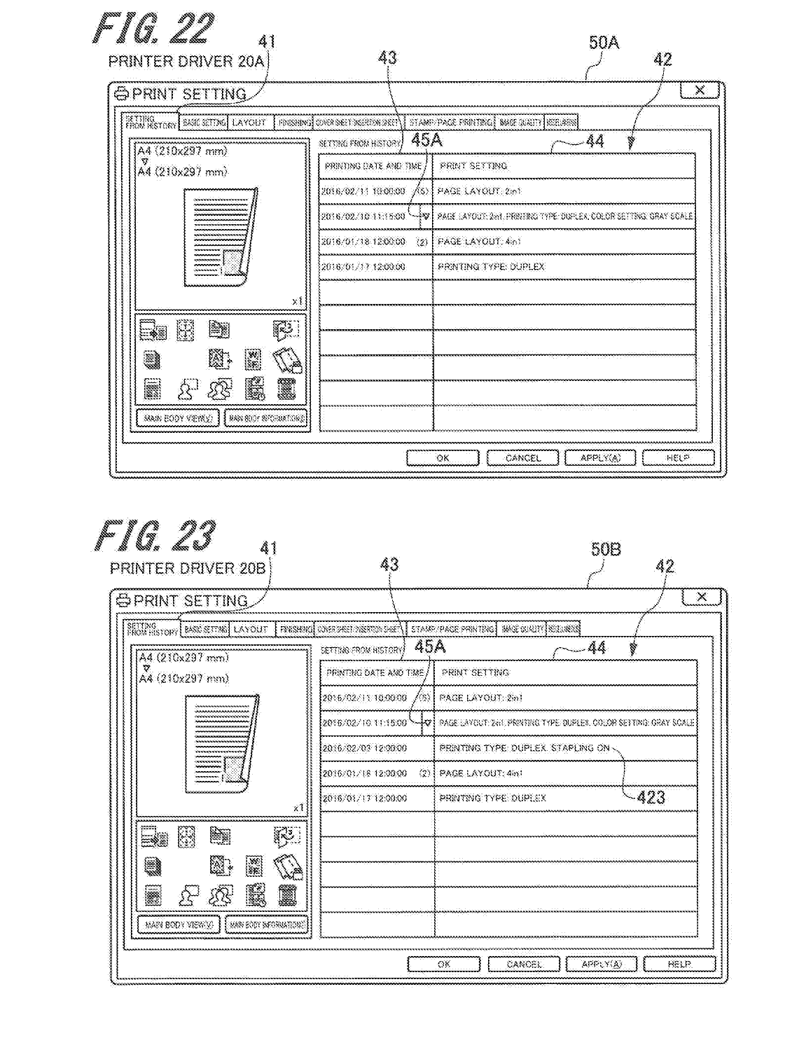

FIG. 22 illustrates an example of a print setting screen (history display) of the printer driver 20A corresponding to the printing apparatus 2. The list of print setting histories 42 on a print setting screen 50A of FIG. 22 is displayed by the UI processing unit 211 on the basis of the UI display data (master) of FIG. 20.

In the UI display data (master) of FIG. 20 described above, setting of “non-display” is performed on a print setting history record including a print setting accompanied with setting information for a function unavailable in the printing apparatus 2 (stapling, in the present example). Therefore, print setting histories with the history IDs ‘207’ and ‘203’ including the setting information of stapling are not displayed on the print setting screen 50A of the selected printer driver 20A (connected to the printing apparatus 2).

[Example of Print Setting Screen (2)]

FIG. 23 illustrates an example of a print setting screen (history display) of the printer driver 20B corresponding to the printing apparatus 3. The list of print setting histories 42 of a print setting screen 50B of FIG. 23 is displayed by the UI processing unit 211 on the basis of the UI display data (master) of FIG. 21.

In the UI display data (master) of FIG. 21 described above, there is no setting information for functions unavailable in the printing apparatus 3. Therefore, a print setting history 423 corresponding to the print setting history record with the history ID ‘203’ including the setting information of stapling is displayed on the print setting screen 50B of the selected printer driver 20B (connected to the printing apparatus 3). In addition, the print setting history record with the history ID ‘207’ including the setting information of stapling is a child history of the print setting history record with the history ID ‘208’ and thus is not displayed on the print setting screen 50B of FIG. 21. The print setting history corresponding to print setting history record with the history ID ‘207’ is displayed by clicking the downward arrow mark 45A displayed in the print setting history with the printing date and time “2016/02/10 11:15:00” corresponding to the history ID ‘208’, as illustrated in FIG. 16.

### Effect of the Second Embodiment

According to the abovementioned second embodiment, the history display processing unit 212 of the printer drivers 20A and 20B display, on the print setting screen of the selected printer driver, the print setting history of the printer drivers 20A and 20B stored in the print setting history holding unit 23. At this time, similarly to the first embodiment, only the latest print setting history, from among print setting histories classified into the same group satisfying predetermined conditions (same document, same print setting), is displayed in the list of print setting histories 42.

Therefore, a list of print setting histories of two printer drivers can be displayed, and the number of print setting histories to be displayed in the list of print setting histories on the print setting screen is reduced. Accordingly, the search characteristics in searching a desired print setting from a list of print setting histories are enhanced while the print setting histories of a plurality of printer drivers are displayed. Note that, although the number of printer drivers is assumed to be two in the present embodiment, it is needless to say that there may be three or more of them.

In addition, it is possible to prevent a print setting for a function unavailable in the selected printing apparatus by excluding the print setting histories including setting information for a function unavailable in a printing apparatus corresponding to the selected printer driver, from being displayed.

### 3. Third Embodiment

A third embodiment includes a server that manages a plurality of printing apparatuses connected to a network, and is an example of displaying, on a print setting screen, print setting histories of a plurality of printing apparatuses (to which a printer driver corresponds) stored in the server.

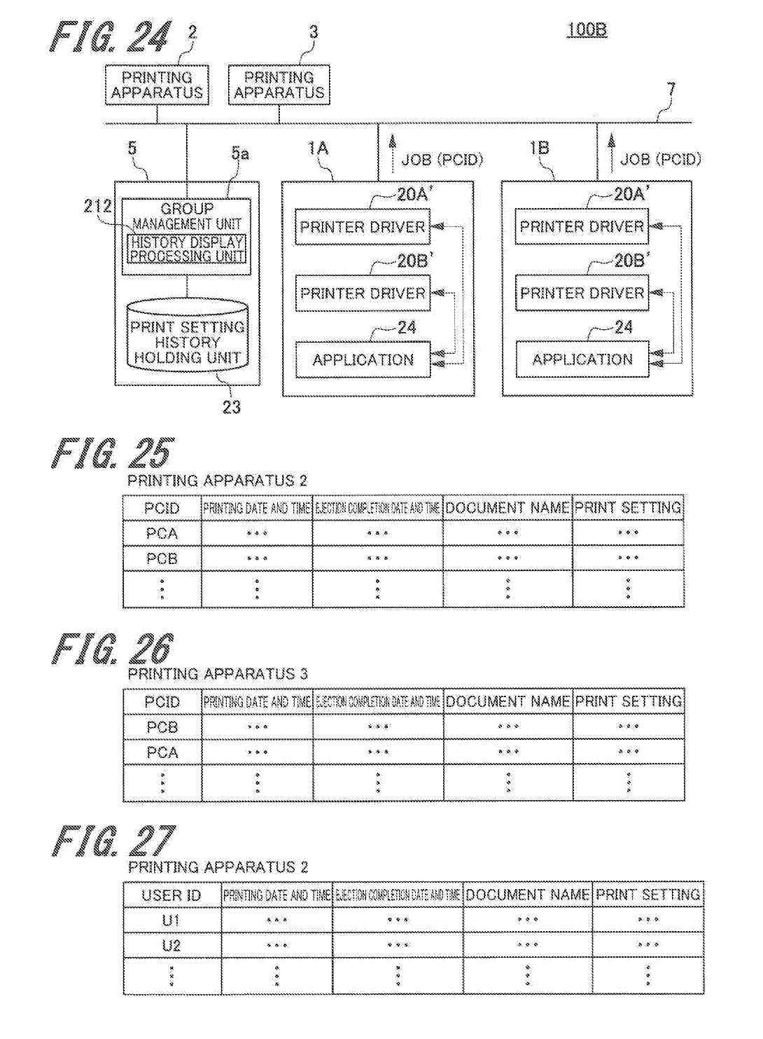

FIG. 24 is a block diagram illustrating an overall configuration of a printing system according to the third embodiment.

In a printing system 100B of FIG. 24, a plurality of client terminals such as PC 1A and PC 1B, the printing apparatuses 2 and 3, and the server 5 are connected to the network 7. The present embodiment is configured such that the server 5 is provided with the functions of the print setting history holding unit 23 and the history display processing unit 212. Although the printing apparatus 4 of FIG. 1 is excluded in FIG. 24 for ease of explanation, each of the number of printing apparatuses and PCs may be three or more, without being limited to the example.

In the PCs 1A and 1B, there are installed the printer driver 20A′ for instructing the printing apparatus 2 to perform printing, the printer driver 20B′ for instructing the printing apparatus 3 to perform printing, and the application 24. The hardware configuration of the PCs 1A and 1B is similar to that of FIG. 2. Although the basic configuration of the printer drivers 20A′ and 20B′ is basically the same as the one illustrated in FIG. 3, the history display processing unit 212 has been relocated to the server 5.

The printer drivers 20A′ and 20B′ create a print job including a print setting and print data on the basis of a print instruction from the user. Then, each of the printer drivers 20A′ and 20B′ performs processing of adding, to the print job, an ID (hereinafter, referred to as “PCID”) which is a piece of information for identifying the PC, and of transmitting the print job to each of the corresponding printing apparatus 2 or 3, via the communication I/F unit 16 (FIG. 2). Addition of a PCID to the print job allows the printing apparatus to recognize from which PC the print job has been transmitted. As long as a PC can be uniquely identified, any PCID, for example, an IP (Internet Protocol) address or a MAC (Media Access Control) address can be used.

The server 5 is provided with a group management unit 5a and the print setting history holding unit 23.

The group management unit 5a unitarily manages, as a single group, a plurality of printing apparatuses (for example, the printing apparatuses 2 and 3 of FIG. 24) connected to the network 7, and acquires, as print setting histories, the contents of print setting at the time of performing printing by respective printing apparatuses and information of documents subjected to printing processing, via the communication I/F unit 16 (FIG. 2). The group management unit 5a stores the acquired print setting histories in the print setting history holding unit 23, in chronological order. The printing apparatuses 2 and 3 transmit the print setting histories to the group management unit 5a, upon executing printing.

Although the group management unit 5a manages, as a single group, a plurality of printing apparatuses connected to the network 7, for example, only a printing apparatus currently communicable on the network 7 may be managed. Alternatively, only a printing apparatus on the network 7, corresponding to the printer drivers 20A′ and 20B′ stored in the PCs 1A and 1B may be managed.

In addition, the group management unit 5a is provided with the history display processing unit 212. The function of the history display processing unit 212 is basically the same as that described in FIG. 3. The history display processing unit 212 classifies the print setting histories stored in the print setting history holding unit 23 into groups satisfying predetermined conditions. Furthermore, the history display processing unit 212 performs processing of generating UI display data (master) for displaying, on the print setting screen of the printer drivers 20A′ and 20B′ selected in the PCs 1A and 1B, only the latest print setting history from among print setting histories classified into the same group.

In the third embodiment, similarly to the second embodiment, setting of “non-display” is performed on a print setting history record including setting information for a function which is not supported by the printing apparatus in the UI display data (master) generating processing of the flowchart of FIG. 8. When, for example, the stapling function is not provided in the printing apparatus 2, setting of “non-display” is performed on the print setting history records with the history IDs including the setting information of stapling.

On the other hand, when the printing apparatus 3 has, for example, a stapling function, setting of “non-display” is not performed for any of the print setting history records. Note that functions that are not supported by the printing apparatuses 2 and 3 include, besides the functions that are not installed in the printing apparatuses 2 and 3, functions unavailable for some reason in a current state of the printing apparatuses 2 and 3. There are included cases of, for example, running out of stapler needles, not being capable of color printing without replenishing color toner, and the like. The printer drivers 20A′ and 20B′ hold information of functions which are available and functions which have turned unavailable, in the corresponding printing apparatuses 2 and 3.

Then, the history display processing unit 212 performs processing of transmitting the UI display data (master) to the PCs 1A and 1B via the communication I/F unit 16 (FIG. 2). Here, the history display processing unit 212 adds, to each of the print setting history records of the UI display data (master), identification information of the PC 1A or the PC 1B which has instructed printing, and stores each of the records in the print setting history holding unit 23. Subsequently, the history display processing unit 212 performs processing of transmitting the UI display data (master) to the PC 1A or PC 1B at a predetermined timing. The predetermined timing is, for example, a periodical timing, or a timing at which a command requesting transmission of the UI display data (master) is received from each printing apparatus.

[Example of Print Job]

FIG. 25 illustrates an example in which a PCID is included in a print job of the printing apparatus 2.

FIG. 26 illustrates an example in which a PCID is included in a print job of the printing apparatus 3.

As illustrated in FIGS. 25 and 26, an ID of the PC which has transmitted the print job is associated with a print job executed by the printing apparatuses 2 and 3.

According to the abovementioned third embodiment described above, the server 5 is provided with the print setting history holding unit 23 and the history display processing unit 212, and performs processing of storing print setting histories of a plurality of printing apparatuses and of generating UI display data (master). Accordingly, the third embodiment exerts an effect of allowing reduction of PC memory resources and reduction of processing load, in addition to the effect by the first and the second embodiments.

### Modified Example

In a company, a PC may be shared by a plurality of users, and in such case, it is necessary for the printing apparatus to grasp which user has instructed the printing.

FIG. 27 illustrates an example in which a user ID is included in a print job of the printing apparatus 2.

For example, a user inputs his or her user ID (example of identification information) and a password to the PC 1A, and logs in. When the user instructs printing by the printer driver 20A′, the printer driver 20A′ adds the user ID to a print job, and transmits the print job to the corresponding printing apparatus 2. Then, as illustrated in FIG. 27, the print job in which printing is executed by the printing apparatus 2 is associated with the ID of the user who has transmitted the print job.

Addition of the user ID to the print job allows the printing apparatus to recognize which user has instructed the printing.

### 4. Others

In the first to the third embodiments, the list of print setting histories 42 on a print setting screen may first display all the print setting histories (e.g., print setting history data of FIG. 7), and a latest-history-display button may be prepared on the print setting screen. When a user operates the latest-history-display button, the history display processing unit 212 performs classification processing of print setting histories to thereby generate UI display data (FIGS. 12 to 14), and the UI processing unit 211 may display the latest print setting history in each group as illustrated in FIG. 15.

Furthermore, it goes without saying that the present invention is not limited to the respective embodiments described above, and that various application examples and modified examples can be adopted without deviating from the gist of the present invention described in the accompanying claims.

For example, the abovementioned embodiments are intended to describe the components of devices and systems in a detailed and specific manner for the purpose of explaining the present invention in a comprehensible manner, and thus are not limited to those including all of the abovementioned components. In addition, a part of the components of a certain embodiment can be replaced by components of other embodiments. Furthermore, components of other embodiments can also be added to the components of a certain embodiment. Moreover, a part of the components of respective embodiments can also be added to, deleted from, or replace other components.

In addition, a part or all of the abovementioned components, functions, processing units, processors, or the like, may be realized by hardware through the design or the like of an integrated circuit. Furthermore, the abovementioned components, functions, or the like, may be realized by software in a manner such that a processor interprets and executes programs that realize respective functions. Information such as programs, tables, files, or the like for realizing respective functions can held in a recording device such as a memory, a hard disk, or an SSD (Solid State Drive), or in a storage medium such as an IC card, an SD card, or a DVD.

In addition, as to control lines or information lines, those considered necessary for explanation are illustrated, and not all the control lines or information lines are necessarily illustrated in a product. Actually, it may be considered that almost all the components are connected to each other.

Additionally, in the present specification, processing steps describing chronological processing are intended to include not only chronologically-performed processing in a specified order, but also processing performed in parallel or individually (e.g., parallel processing or object-based processing), which are not necessarily performed in a chronological order.

Although the present invention has been described and illustrated in detail, it is clearly understood that the same is by way of illustrated and example only and is not to be taken by way limitation, the scope of the present invention being interpreted by terms of the appended claims.

### REFERENCE SIGNS LIST

1,1A,1B . . . PC, 2 to 4 . . . printing apparatus, 5 . . . server, 5a . . . group management unit, 11 . . . CPU, 20,20A,20B,20A′,20B′ . . . printer driver, 21 . . . print setting UI unit, 22 . . . rendering unit, 23 . . . print setting history holding unit, 25 . . . print setting screen, 40,40A . . . print setting screen, 41 . . . setting-from-history tab, 42 . . . list of print setting history, 43 . . . printing date-and-time field, 44 . . . print setting field, 45A . . . downward arrow mark, 45B . . . upward arrow mark, 211 . . . UI processing unit (screen display processing unit), 212 . . . history display processing unit, 213 . . . print setting processing unit, 221 . . . drawing data generating unit, 222 . . . history storage processing unit

What is claimed is:

1. A non-transitory recording medium storing a computer readable print setting history display program for causing a computer to execute:
storing, as print setting histories, contents of print setting at a time of performing printing and information of documents subjected to printing processing in a print setting history holding unit;
displaying a list of the print setting histories stored in the print setting history holding unit on a print setting screen on which print setting is performed; and
performing a print setting on a basis of a print setting history selected from the list of the print setting histories displayed on the print setting screen, wherein
in the displaying of the list of the print setting histories on the print setting screen, only the latest print setting history is displayed from among print setting histories classified into a same group satisfying predetermined conditions.

2. The non-transitory recording medium storing a computer readable print setting history display program according to claim 1, wherein
the displaying of the list of the print setting histories classifies print setting histories of respective printing processing into a same group and displays only the print setting history of the final printing processing in a case where a same document has been subjected to printing processing a plurality of times with print setting changed, or classifies print setting histories of respective printing processing into a same group and displays only the print setting history of the latest printing processing in a case where printing processing has been performed in a same print setting as a past print setting.

3. The non-transitory recording medium storing a computer readable print setting history display program according to claim 2, wherein
print setting histories other than the print setting history at a time of final printing processing of a corresponding document in the same group upon receiving an instruction are also displayed in a case where the same document has been subjected to printing processing a plurality of times with the contents of print setting changed.

4. The non-transitory recording medium storing a computer readable print setting history display program according to claim 2, wherein
the number of print setting histories having the same print setting classified into the same group is displayed in a case where printing has been performed in the same print setting as the plurality of print setting histories.

5. The non-transitory recording medium storing a computer readable print setting history display program according to claim 2, wherein
a condition in which an interval between times of executing printing processing of the same document is within a particular time period is included as one of the predetermined conditions.

6. The non-transitory recording medium storing a computer readable print setting history display program according to claim 5, wherein
the particular time period does not include a time period required from instruction of printing processing to completion of the printing processing.

7. The non-transitory recording medium storing a computer readable print setting history display program according to claim 2, wherein
setting items to be compared when performing classification into the group under the same-print-setting condition are all the setting items described in a print setting field of the print setting histories.

8. The non-transitory recording medium storing a computer readable print setting history display program according to claim 2, wherein
setting items to be compared when performing classification into the group under the same-print-setting condition have arbitrary setting items excluded from all the setting items described in a print setting field of the print setting histories, and the arbitrary setting items include at least any one of: number of copies, document size, and document orientation.

9. The non-transitory recording medium storing a computer readable print setting history display program according to claim 2, wherein
setting items to be compared when performing classification into the group under the same-print-setting condition includes at least any one of: page layout, duplex or simplex, color setting, and post-processing function.

10. The non-transitory recording medium storing a computer readable print setting history display program according to claim 1, wherein
the print setting history holding unit has stored therein print setting histories of a plurality of printer drivers, and the displaying of the list of the print setting histories displays, on a print setting screen of a selected printer driver, only the latest print setting history from among print setting histories classified into a same group satisfying predetermined conditions, by using print setting histories of the plurality of printer drivers stored in the print setting history holding unit.

11. The non-transitory recording medium storing a computer readable print setting history display program according to claim 10, wherein
print setting histories including setting information for a function unavailable in a printing apparatus corresponding to the selected printer driver are made non-display.

12. A printing system having connected thereto a plurality of printing apparatuses, an information processing apparatus having printer drivers corresponding to the plurality of printing apparatuses, and a server,
the server including:
a group management unit configured to manage the plurality of printing apparatuses and acquire, as print setting histories, contents of print setting at a time of performing printing by the printing apparatuses and information of documents subjected to printing processing; and
a print setting history holding unit configured to store the print setting histories acquired by the group management unit, and
the information processing apparatus including:
a history display processing unit configured to classify the print setting histories stored in the print setting history holding unit of the server into groups satisfying predetermined conditions;
a screen display processing unit configured to perform processing of displaying, on a print setting screen of a selected printer driver, only the latest print setting history from among the print setting histories in each group as a list of print setting histories stored in the print setting history holding unit; and
a print setting processing unit configured to perform print setting on a basis of a print setting history selected from the list of the print setting histories displayed on the print setting screen.

13. A server for use in a printing system having connected thereto a plurality of printing apparatuses and an information processing apparatus having printer drivers corresponding to the plurality of printing apparatuses,
the server comprising:
a group management unit configured to manage the plurality of printing apparatuses and acquire, as print setting histories, contents of print setting at a time of performing printing by the printing apparatuses and information of documents subjected to printing processing; and
a print setting history holding unit configured to store the print setting histories acquired by the group management unit, and
the group management unit including:
a history display processing unit configured to perform processing of classifying the print setting histories stored in the print setting history holding unit into groups satisfying predetermined conditions, of generating display data for displaying, on a print setting screen of a selected printer driver, only the latest print setting history from among the print setting histories classified into a same group satisfying predetermined conditions in the information processing apparatus, and of transmitting the display data to the information processing apparatus.

14. Anon-transitory recording medium storing a computer readable print setting history display program for causing a computer that is built in a server used for a printing system having connected thereto a plurality of printing apparatuses and an information processing apparatus having printer drivers corresponding to the plurality of printing apparatuses, to execute:
managing the plurality of printing apparatuses and acquiring, as print setting histories, contents of print setting at a time of performing printing by the printing apparatuses and information of documents subjected to printing processing;
storing the acquired print setting histories; and
classifying the stored print setting histories into groups satisfying predetermined conditions, generating display data for displaying, on a print setting screen of a selected printer driver, only the latest print setting history from among print setting histories classified into a same group satisfying predetermined conditions in the information processing apparatus, and transmitting the display data to the information processing apparatus.

15. The non-transitory recording medium storing a computer readable print setting history display program according to claim 14, wherein, in the display data, setting is performed in which print setting histories including setting information for a function unavailable in a printing apparatus corresponding to the selected printer driver are made non-display.
